(19) United States
(12) Patent Application Publication
(10) Pub. No.: US 2024/0066690 A1
(43) Pub. Date: Feb. 29, 2024

(54) NUMERICAL CONTROL APPARATUS AND NUMERICAL CONTROL SYSTEM

(71) Applicant: FANUC CORPORATION, Yamanashi (JP)

(72) Inventor: Ryou NAKAMURA, Yamanashi (JP)

(73) Assignee: FANUC CORPORATION, Yamanashi (JP)

(21) Appl. No.: 18/260,848

(22) PCT Filed: Jan. 27, 2022
(86) PCT No.: PCT/JP2022/003029

§ 371 Date: Jul. 10, 2023

(30) Foreign Application Priority Data
Jan. 29, 2021 (JP) 2021-012707

(51) Int. Cl. B25J 9/16

(52) U.S. Cl. CPC B25J 9/1628

(57) ABSTRACT

This numerical control apparatus 5 controls the operation of a machine tool 2 on the basis of a numerical control program, generates, for a robot control device 6 that controls the operation of a robot 3 and a transfer device 4 which moves the robot 3, a robot command for moving a control axis of the robot 3 and a travel axis command for moving a travel axis of the transfer device 4, and inputs the generated commands to the robot control device 6. The numerical control apparatus 5 comprises: a coordinate value management unit 55 that acquires, respectively as additional axis reference coordinate values and robot reference coordinate values, coordinate values of the travel axis of the transfer device 4 and the control axis of the robot 3 acquired by the robot control device 6; and a command generation unit 56 that generates the robot command and the travel axis command on the basis of the numerical control program, the robot reference coordinate values, and travel axis reference coordinate values.

### TECHNICAL FIELD

The present disclosure relates to a numerical control apparatus and a numerical control system.

### BACKGROUND ART

In recent years, in order to promote automation of a machining site, a numerical control system has been desired which links and controls operation of a machine tool machining a workpiece and operation of a robot provided in the vicinity of this machine tool (for example, refer to Japanese Patent No. 6647472).

Generally, a numerical control program for controlling a machine tool and a robot program for controlling a robot differ in programming language. In order to interlock the operation of a machine tool and the operation of a robot, it is necessary for the operator to familiarize with both the numerical control program and robot program.

Japanese Patent No. 6647472 discloses a numerical control apparatus which controls both a machine tool and robot by a numerical control program. More specifically, the numerical control system disclosed in Japanese Patent No. 6647472 generates a robot command in accordance with the numerical control program in the numerical control apparatus, generates a robot program based on this robot command in the robot control device, and generates a robot control signal for controlling the operation of the robot in accordance with this robot program. According to the numerical control system shown in Japanese Patent No. 6647472, so long as being a user familiarized with the numerical control program, it is possible to also control a robot without familiarizing with the robot program.
Patent Document 1: Japanese Patent No. 6647472

### DISCLOSURE OF THE INVENTION

### Problems to be Solved by the Invention

However, in the case of using a robot in a machining site, there are cases of installing a robot to a transfer device including an additional axis such as a travel axis and/or rotation axis for expanding the operation range of the robot, and establishing the robot as free moving on the additional axis of this transfer device. Therefore, it has been considered to expand the functions of the numerical control apparatus such as that shown in Japanese Patent No. 6647472 so as to generate in the numerical control apparatus not only a robot command for controlling the operation of the robot, but also a command for controlling the additional axis of the transfer device which moves this robot in accordance with a shared numerical control program.

However, when installing a robot on a transfer device, the coordinate value of the robot also changes by the movement of the additional axis. For this reason, when trying to generate commands for both the robot and transfer device on the side of the numerical control apparatus, it is necessary to appropriately execute, on the side of the numerical control apparatus, a coordinate conversion processing between the robot coordinate system in which the coordinate value of the control axis of the robot is defined and the additional axis coordinate system in which the coordinate value of the additional axis is defined, and the processing load on the numerical control apparatus increases, and consequently, there is concern over the machining performance of the machine tool and robot declining.

The present disclosure provides a numerical control apparatus and numerical control system which can generate commands for a robot and a transfer device moving this robot with little processing load.

### Means for Solving the Problems

An aspect of the present disclosure provides a numerical control apparatus for controlling operation of a machine tool based on a numerical control program, and generating and inputting to the robot control device, in relation to a robot control device which controls operations of a robot and of a transfer device that moves the robot, a robot command for moving a robot control axis of the robot and an additional axis command for moving an additional axis of the transfer device, the numerical control apparatus including: a coordinate value manager which acquires coordinate values of the robot control axis and the additional axis acquired in the robot control device, respectively, as a robot reference coordinate value and an additional axis reference coordinate value; and a command generation unit which generates the robot command and the additional axis command based on the numerical control program, the robot reference coordinate value and the additional axis reference coordinate value.

An aspect of the present disclosure provides a numerical control system including: a numerical control apparatus which controls operation of a machine tool based on a numerical control program, and generates a robot command for moving a control axis of a robot and an addition axis command for moving an additional axis of a transfer device which moves the robot; and a robot control device which is configured to be communicably with the numerical control apparatus, and controls operation of the robot and the transfer device based on the robot command and the additional axis command sent from the numerical control apparatus, in which the robot control device includes: a coordinate value control unit which acquires a coordinate value of the robot control axis and a coordinate value of the additional axis according to a coordinate value acquisition request sent from the numerical control apparatus, and sends these to the numerical control apparatus, and an operation control unit which controls operation of the robot and the transfer device based on the robot command and the additional axis command; and in which the numerical control apparatus includes: a coordinate value manager which acquires a coordinate value of the robot control axis and a coordinate value of the additional axis sent from the robot control device, respectively, as a robot reference coordinate value and an additional axis reference coordinate value, and a command generation unit which generates the robot command and the additional axis command, based on the numerical control program, the robot reference coordinate value and the additional axis reference coordinate value.

### Effects of the Invention

According to an aspect of the present disclosure, a numerical control apparatus includes a coordinate value manager and a command generation unit. The coordinate value manager acquires coordinate values of the robot control axis and the additional axis sent from the robot control device, respectively, as a robot reference coordinate value and an additional axis reference coordinate value. In addition, the command generation unit generates a robot command for moving the robot control axis and an additional axis command for moving the additional axis, based on the numerical control program and the robot reference coordinate value and the additional axis reference coordinate value acquired from the robot control device, and inputs this robot command and additional axis command to the robot control device. According to the aspect of the present disclosure, the numerical control apparatus acquires a robot reference coordinate value and additional axis reference coordinate value from the robot control device which directly controls operations of the robot and the transfer device moving this robot itself, and generates a robot command and additional axis command based on this reference coordinate value and numerical control program, whereby the numerical control apparatus can generate a robot command and additional axis command without performing a coordinate conversion processing between the coordinate system in which the coordinate value of the robot control axis is defined and the coordinate system in which the coordinate value of the additional axis is defined; therefore, it is possible to generate the robot command and additional axis command with little processing load.

### BRIEF DESCRIPTION OF THE DRAWINGS

FIG. 1 is a schematic drawing of a numerical control system according to an embodiment of the present disclosure;

FIG. 2 is a functional block diagram of a numerical control apparatus and a robot control device;

FIG. 3 is a flowchart showing a specific sequence of coordinate value acquisition request generation processing;

FIG. 4 is a flowchart showing a specific sequence of a coordinate value update processing;

FIG. 5 is an example of a robot program; and

FIG. 6 is a sequence diagram showing the flow of signals and information between the numerical control apparatus and robot control device in the case of operating the numerical control apparatus based on the robot program exemplified in FIG. 5.

### PREFERRED MODE FOR CARRYING OUT THE INVENTION

Hereinafter, a numerical control system 1 according to an embodiment of the present disclosure will be explained by referencing the drawings.

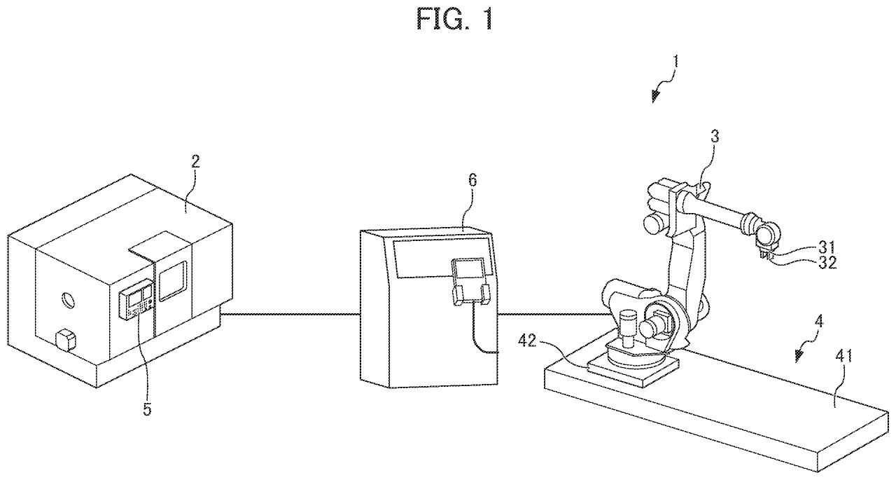

FIG. 1 is a schematic drawing of the numerical control system 1 according to the present embodiment.

The numerical control system 1 includes: a machine tool 2; a numerical control apparatus (CNC) 5 controlling this machine tool 2; a robot 3 provided in the vicinity of the machine tool 2; a transfer device 4 for moving this robot 3; and a robot control device 6 connected to be able to communicate with the numerical control apparatus 5. The numerical control apparatus 5 controls operation of the machine tool 2 based on a predetermined numerical control program, and generates a command for the robot control device 6 for controlling operation of the robot 3 and transfer device 4, and sends this to the robot control device 6. The robot control device 6 controls operation of the robot 3 and transfer device 4 in response to the command sent from the numerical control apparatus 5.

The machine tool 2 machines a workpiece (not shown) according to machine tool control signals sent from the numerical control apparatus 5. Herein, the machine tool 2 is a lathe, drill press, milling machine, grinding machine, laser processing machine, injection molding machine or the like.

The robot 3 operates under the control of the robot control device 6, and performs a predetermined operation on the workpiece machined by the machine tool 2, for example. The robot 3 is an articulated robot, for example, and a tool 32 for holding, machining or inspecting the workpiece is mounted to an arm tip end 31 thereof. Hereinafter, a case of the robot 3 being a 6-axis articulated robot will be explained; however, it is not to be limited thereto. In addition, hereinafter, a case of the robot 3 being a 6-axis articulated robot will be explained; however, the number of axes is not limited thereto.

The transfer device 4 includes a base 41 placed on the floor F, a slider 42 provided to be freely slidable along a horizontal direction relative to this base 41, and an actuator (not shown) causing the slider 42 to move relative to the base 41. The base 41 supports the slider 42 to be slidable along a travel axis parallel with a horizontal surface. The robot 3 is fixed to the slider 42. The transfer device 4 moves under the control of the robot control device 6, and moves the robot 3 by moving the travel axis of the slider 42. It should be noted that, although the present embodiment explains an example of the transfer device 4 including the travel axis which is one axis as an additional axis, i.e. the transfer device 4 in which the slider 42 and robot 3 are moveable only along one travel axis, the present disclosure is not limited thereto. The axis number of the travel axis may be established as two or more axes, and may use a rotation axis as an additional axis.

The numerical control apparatus 5 and robot control device 6 are each a computer configured by hardware such as an operation processing means such as a CPU (Central Processing Unit), an auxiliary storage means such as HDD (Hard Disk Drive) or SSD (Solid State Drive) storing various programs, a main storage means such as RAM (Random Access Memory) for storing data temporarily necessitated upon the operation processing means executing programs, an operation means such as a keyboard on which an operator performs various operations, and a display means such as a display that displays various information to the operator. This robot control device 6 and numerical control apparatus 5 are able to transmit various signals with each other by the Ethernet (registered trademark), for example.

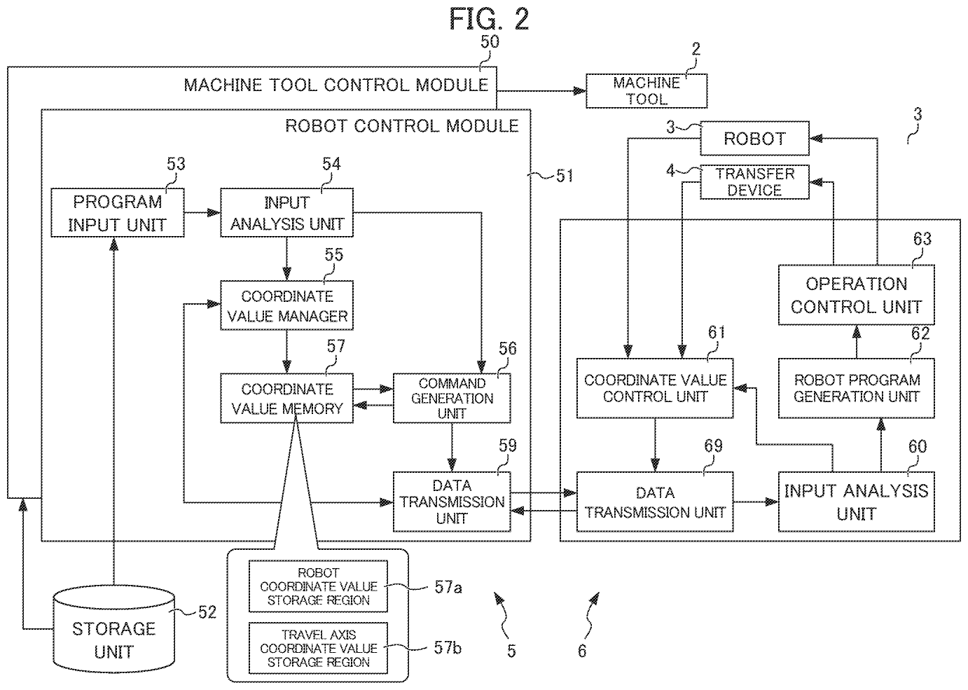

FIG. 2 is a functional block diagram of the numerical control apparatus 5 and robot control device 6.

The numerical control apparatus 5 generates various commands for controlling operation of the robot 3 and a tool 32 mounted to this robot 3, and the transfer device 4 (hereinafter the robot 3, tool 32 and transfer device 4 are collectively referred to as “robot 3, etc.”) in accordance with the sequence explained below, and sends the generated commands to the robot control device 6. Based on the commands sent from the numerical control apparatus 5, the robot control device 6 generates a robot control signal for controlling operation of the robot 3 in accordance with the sequence explained below, generates I/O signals for controls operation of the tool 32, and generates a transfer device control signal for controlling operation of the transfer device 4, and inputs these generated signals to the robot 3, etc. The robot control device 6 thereby controls operation of the robot 3, etc.

First, a detailed configuration of the numerical control apparatus 5 will be explained. As shown in FIG. 2, in the numerical control apparatus 5, various functions such as of a machine tool control module 50 as a control system of the machine tool 2, a robot control module 51 as a control system of the robot 3, etc., and a storage unit 52 are realized by the above-mentioned hardware configuration.

A plurality of numerical control programs created based on operations by the operator, for example, are stored in the storage unit 52. More specifically, the storage unit 52 mainly stores numerical control programs for the machine tool configured by a plurality of command blocks for the machine tool 2 (hereinafter referred to as “machine tool program”), numerical control programs for the robot configured by a plurality of command blocks for the robot 3, etc. (hereinafter referred to as “robot program”), etc. This machine tool program and robot program are written in a common programming language (for example, G code, M code or the like).

The machine tool program is written based on machine tool coordinate system with a reference point decided at any position on the machine tool 2 or in the vicinity of the machine tool 2 as the origin. In other words, in the machine tool program, the position and posture of the control point of the machine tool 2 is written according to the coordinate value defined by the machine tool coordinate system.

The robot program is written based on the robot coordinate system and travel axis coordinate system, which differ from the machine tool coordinate system. In other words, in the robot program, the position and posture of the control point of the robot 3 (for example, arm tip end 31 of the robot 3), i.e. the position of each control axis of the robot 3, are written according to the coordinate values defined by the robot coordinate system. In addition, in the robot program, the position on the travel axis of the transfer device 4 is written according to the coordinate value defined by the travel axis coordinate system.

The robot coordinate system is a coordinate system with a reference point decided at any position on the robot 3 or in the vicinity of the robot 3 as the origin. It should be noted that, hereinafter, a case of the robot coordinate system differing from the machine tool coordinate system will be explained; however, it is not limited thereto. The robot coordinate system may be made to match the machine tool coordinate system. In other words, the origin and coordinate axis directions of the robot coordinate system may be made to match the origin and coordinate axis directions of the machine tool coordinate system.

In addition, in this robot program, the robot coordinate system is switchable between at least two coordinate formats with different control axes. More specifically, the position and posture of the control point of the robot 3 in the robot program can be designated by orthogonal coordinate format or joint coordinate format.

In the joint coordinate format, the position and posture of the control point of the robot 3 are designated by the six real number coordinate values with components of the rotation angle values of the six joints of the robot 3 (J1, J2, J3, J4, J5, J6).

In the orthogonal coordinate format, the position and posture of the control point of the robot 3 are designated by a total of six real number coordinate values with components of the three coordinate values (X, Y, Z) along the three orthogonal coordinate axes, and three rotation angle values (A, B, C) around each orthogonal coordinate axis.

Herein, under the joint coordinate format, in order to directly designate the rotation angle of each joint of the robot 3, the axis arrangement of each arm and/or wrist of the robot 3, and rotation number of a joint rotatable by at least 360 degrees (hereinafter these are abbreviated and referred to as “form of robot 3”) are also uniquely fixed. In contrast, under the orthogonal coordinate format, due to designating the position and posture of the control point of the robot 3 by six coordinate values (X, Y, Z, A, B, C), the form of the robot 3 cannot be uniquely fixed. Therefore, with the numerical control program for the robot, it becomes possible to designate the form of the robot 3 by a form value P, which is an integer value of a predetermined number of digits. Therefore, the position and posture of the control point of the robot 3 as well as the form of the robot 3 are represented by the six coordinate values (J1, J2, J3, J4, J5, J6) under the joint coordinate format, and are represented by the six coordinate values and one form value (X, Y, Z, A, B, C, P) under the orthogonal coordinate format. It should be noted that, hereinafter, the shape value P also refers to a coordinate value, for convenience.

In the robot program, the coordinate format of the robot coordinate system can be switched between the orthogonal coordinate format and joint coordinate format, by G code “G68.8” and “G68.9”, which are coordinate format switch commands of the robot coordinate system. More specifically, by inputting G code “G68.8”, the coordinate format of the robot coordinate system is set to the joint coordinate format, and by inputting G code “G68.9”, the coordinate format of the robot coordinate system is set to the orthogonal coordinate format. The G code “G68.8” and “G68.9” for setting these coordinate formats are modal. Therefore, the coordinate format is maintained after setting the coordinate format by these G code to the joint coordinate format or the orthogonal coordinate format, until the coordinate format is changed by these G codes again. It should be noted that, in the present embodiment, in the case of the G code for setting these coordinate formats of the robot coordinate system not being written in the robot program, the coordinate format shall be set automatically to the orthogonal coordinate format; however, it is not limited thereto.

The travel axis coordinate system is the coordinate system of the same dimensions as the number of travel axes with a reference point decided at any position on the transfer device 4 or in the vicinity of the transfer device 4 as the origin. the present embodiment explains a case of establishing the travel axis as one axis, i.e. case of establishing the travel axis coordinate system as one dimension; however, it is not limited thereto. In addition, the present embodiment explains a case of making the travel axis and Y axis in the above-mentioned orthogonal coordinate formed to be parallel; however, it is not limited thereto. In other words, the present embodiment explains a case of the position in the travel axis of the transfer device 4 being represented by the one coordinate value (Y2), and the coordinate value of the Y axis in the orthogonal coordinate format of the robot changing by movement in the travel direction; however, it is not limited thereto.

In the robot program, it becomes possible to switch the coordinate system between the travel axis coordinate system and robot coordinate system by the G codes “G17.8” and “G17.9”, which are coordinate system switch commands. More specifically, by inputting the G code “G17.9”, the coordinate system is set to the travel axis coordinate system, and by inputting the G code “G17.8”, the coordinate system is set to the robot coordinate system. The G codes “G17.8” and “G17.9” for setting these coordinate systems are modal. Therefore, the coordinate system is maintained after setting the coordinate system by these G codes to the robot coordinate system or travel axis coordinate system, until the coordinate system is changed by these G codes again. It should be noted that, in the present embodiment, in the case of G code for setting these coordinate systems not being written in the robot program, the coordinate system shall be set to the robot coordinate system automatically; however, it is not to be limited thereto.

The machine tool control module 50 mainly generates the machine tool control signal for controlling operation of the machine tool 2 in accordance with the machine tool program, and inputs this to actuators (not shown) of the machine tool 2. More specifically, the machine tool control module 50 reads out the machine tool program stored in the storage unit 52, and analyzes the command classification based on the numerical control program, thereby generating the machine tool control signal. The machine tool 2 operates according to the machine tool control signals sent from the machine tool control module 50 to machine a workpiece (not shown).

The robot control module 51 generates various commands for controlling operation of the robot 3, etc. in accordance with the robot program, and sends these to the robot control device 6. More specifically, the robot control module 51 includes a program input unit 53, input analysis unit 54, coordinate value manager 55, command generation unit 56 and data transmission unit 59.

The program input unit 53 reads out the robot program from the storage unit 52, and inputs this successively to the input analysis unit 54.

The input analysis unit 54 analyzes the command classification for every command block based on the robot program inputted from the program input unit 53, and sends the analysis results thereof to the coordinate value manager 55 and command generation unit 56.

The coordinate value manager 55 includes a coordinate value memory 57, which is a storage medium, and manages the robot current coordinate value, which is the current coordinate value of the six control axes of the robot 3, and the travel axis current coordinate value, which is the current coordinate value in the travel axis of the transfer device 4, by using this coordinate value memory 57.

As shown in FIG. 2, the coordinate value memory 57 includes a robot coordinate value storage region 57a which stores the robot current coordinate value, and a travel axis coordinate value storage region 57b which stores the travel axis current coordinate value.

The positions of the six control axes of the robot 3 are defined under the robot coordinate system in the aforementioned way. In addition, in the present embodiment, the robot coordinate system becomes able to switch between the orthogonal coordinate format and the joint coordinate format. The positions of the six control axes of the robot 3 are represented by seven coordinate values (X, Y, Z, A, B, C, P) under the orthogonal coordinate format, and represented by the six coordinate values (J1, J2, J3, J4, J5, J6) under the joint coordinate format. In the robot coordinate value storage region 57a of the coordinate value memory 57, in the case of the designated coordinate format, which is the coordinate format set based on the robot program, being the orthogonal coordinate format, the seven coordinate values (X, Y, Z, A, B, C, P) are stored as the robot current coordinate values, and in the case of the designated coordinate format being the joint coordinate format, the six coordinate values (J1, J2, J3, J4, J5, J6) are stored as the robot current coordinate values. The coordinate values stored in the robot coordinate value storage region 57a are updated as appropriate in accordance with the sequence explained later by the coordinate value manager 55 and command generation unit 56, so as to always be maintained at the latest coordinate values.

The position on the travel axis of the transfer device 4 is represented by one coordinate value (Y2) under the one-dimensional travel axis coordinate system, in the aforementioned away. In the travel axis coordinate value storage region 57b of the coordinate value memory 57, the one coordinate value (Y2) is stored as the travel axis current coordinate value. The coordinate values stored in the travel axis coordinate value storage region 57b are updated as appropriate in accordance with the sequence explained later, by the coordinate value manager 55 and command generation unit 56, so as to always be maintained at the latest coordinate value.

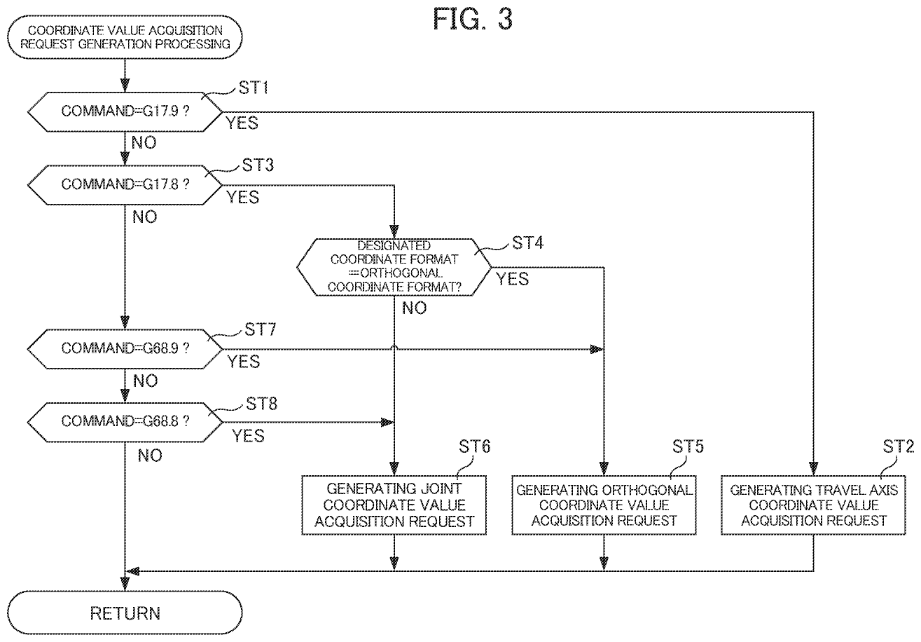

The coordinate value manager 55 determines the necessity for update of the current coordinate values stored in the coordinate value memory 57, based on the analysis result sent from the input analysis unit 54 as explained by referencing FIG. 3 later, and in the case of determining that it is necessary to update the current coordinate value, generates the coordinate value acquisition request to acquire the current coordinate values from the robot control device 6, and writes this coordinate value acquisition request to the data transmission unit 59. As explained later, the robot control device 6 acquires the coordinate value of the control axis of the robot 3 and the coordinate value of the travel axis of the transfer device 4, in response to receiving the coordinate value acquisition request sent from the numerical control apparatus 5, and sends these coordinate values to the numerical control apparatus 5.

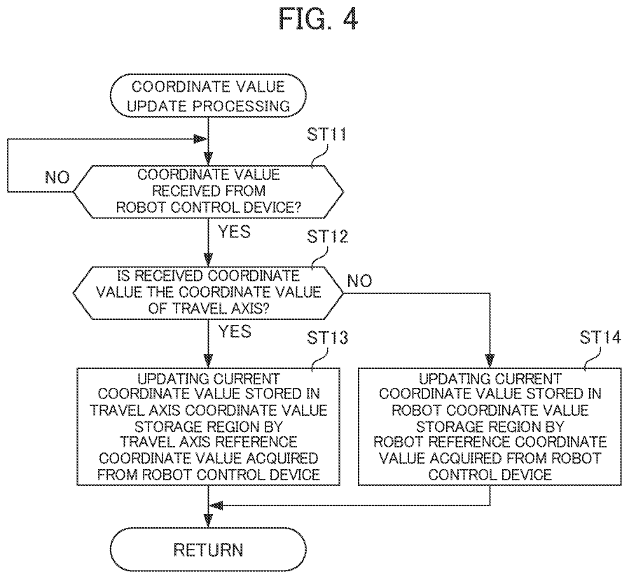

In addition, the coordinate value manager 55 acquires the coordinate value of the control axis of the robot 3 and the coordinate value of the travel axis of the transfer device 4 sent from the robot control device 6 respectively as the robot reference coordinate value and travel axis reference coordinate value, and updates the current coordinate values stored in the coordinate value memory 57 by this robot reference coordinate value and travel axis reference coordinate value, as explained later by referencing FIG. 4.

FIG. 3 is a flowchart showing a specific sequence of coordinate value acquisition request generation processing. The coordinate value manager 55, in the case of a command being the coordinate system switching command (G17.8 or G17.9) or coordinate format switching command (G68.8 or G68.9) based on the robot program (Steps ST1, ST3, ST7 and ST8), executes various processing (Steps ST2, ST4 to ST6) shown in FIG. 3.

In Step ST1, the coordinate value manager 55 determines whether the command is a coordinate system switching command (i.e. G code “G17.9”) of switching the coordinate system to the travel axis coordinate system based on the robot program. The coordinate value manager 55, in the case of the determination result in Step ST1 being NO, advances to Step ST3.

The coordinate value manager 55, in the case of the determination result in Step ST1 being YES, determines that it is necessary to update the current coordinate value stored in the travel axis coordinate value storage region 57 of the coordinate value memory 57, and then advances to Step ST2. In Step ST2, the coordinate value manager 55 generates a travel axis coordinate value acquisition request to request the current coordinate value on the travel axis of the transfer device 4 from the robot control device 6, writes this travel axis coordinate value acquisition request in the data transmission unit 59, and then ends the processing shown in FIG. 3. The data transmission unit 59 thereby sends the travel axis coordinate value acquisition request to the robot control device 6.

In Step ST3, the coordinate value manager 55 determines whether the command is a coordinate system switching command (i.e. G code “G17.8”) for switching the coordinate system to the robot coordinate system based on the robot program. The coordinate value manager 55, in the case of the determination result in Step ST3 being NO, advances to Step ST7.

The coordinate value manager 55, in the case of the determination result in Step ST3 being YES, determines that it is necessary to update the current coordinate value stored in the robot coordinate value storage region 57a of the coordinate value memory 57, and then advances to Step ST4. In Step ST4, the coordinate value manager 55 determines whether the current designated coordinate format is the orthogonal coordinate format.

The coordinate value manager 55, in the case of the determination result in Step ST4 being YES, advances to Step ST5. In Step ST5, the coordinate value manager 55 generates the orthogonal coordinate value acquisition request to request the coordinate value under the orthogonal coordinate format of the current control axis of the robot 3 from the robot control device 6, writes this orthogonal coordinate value acquisition request in the data transmission unit 59, and then ends the processing shown in FIG. 3. The data transmission unit 59 thereby sends the orthogonal coordinate value acquisition request to the robot control device 6.

The coordinate value manager 55, in the case of the determination result in Step ST4 being NO, advances to Step ST6. In Step ST6, the coordinate value manager 55 generates a joint coordinate value acquisition request to request the coordinate values under the joint coordinate format of the current control axis of the robot 3 from the robot control device 6, writes this joint coordinate value acquisition request in the data transmission unit 59, and then ends the processing shown in FIG. 3. The data transmission unit 59 thereby sends the joint coordinate value acquisition request to the robot control device 6.

In Step ST7, the coordinate value manager 55 determines whether the command is a coordinate format switching command (i.e. G code “G68.9”) of switching the coordinate format of the robot coordinate system to the orthogonal coordinate format based on the robot program. The coordinate value manager 55, in the case of the determination result in Step ST7 being NO, advances to Step ST8.

The coordinate value manager 55, in the case of the determination result in Step ST7 being YES, determines that it is necessary to update the current coordinate value stored in the robot coordinate value storage region 57a of the coordinate value memory 57, and then advances to the aforementioned Step ST5. The data transmission unit 59 thereby sends the orthogonal coordinate value acquisition request to the robot control device 6.

In Step ST8, the coordinate value manager 55 determines whether the command is a coordinate format switching command (i.e. G code “G68.8”) of switching the coordinate format of the robot coordinate system to the joint coordinate format based on the robot program. The coordinate value manager 55, in the case of the determination result in Step ST8 being NO, ends the processing shown in FIG. 3.

The coordinate value manager 55, in the case of the determination result in Step ST8 being YES, determines that it is necessary to update the current coordinate value stored in the robot coordinate value storage region 57a of the coordinate value memory 57, and then advances to the aforementioned Step ST6. The data transmission unit 59 thereby sends the joint coordinate value acquisition request to the robot control device 6.

The coordinate value manager 55, in the case of determining the necessity for update of the current coordinate value stored in the coordinate value memory 57 according to the above sequence, and determining that it is necessary to update the current coordinate value, sends the travel axis coordinate value acquisition request, orthogonal coordinate value acquisition request and joint coordinate value acquisition request to the robot control device 6. As explained later, the robot control device 6 acquires the coordinate value of the travel axis of the transfer device 4 or coordinate value of the control axis of the robot 3 in response to receiving these coordinate value acquisition requests, and sends these coordinate values to the numerical control apparatus 5.

FIG. 4 is a flowchart showing a specific sequence of the coordinate value update processing. The coordinate value manager 55 executes the coordinate value update processing shown in FIG. 4, after sending the coordinate value acquisition request to the robot control device 6 by the aforementioned sequence.

In Step ST11, the coordinate value manager 55 determines whether receiving the coordinate values from the robot control device 6. In Step ST11, the coordinate value manager 55 stands by until receiving the coordinate value sent from the robot control device 6 based on the previously sent coordinate value acquisition request, and in the case of receiving the coordinate value (case of determination result in Step ST11 being YES), advances to Step ST12. In Step ST12, the coordinate value manager 55 determines whether the coordinate value received from the robot control device 6 is a coordinate value of the travel axis.

The coordinate value manager 55, in the case of the determination result in Step ST12 being YES, i.e. case of the received coordinate value being a coordinate value of the travel axis of the transfer device 4, acquires the received coordinate value as the travel axis reference coordinate value, and then advances to Step ST13. In Step ST13, the coordinate value manager 55 updates the current coordinate value stored in the travel axis coordinate value storage region 57b of the coordinate value memory 57 by the acquired travel axis reference coordinate value, and then ends the processing shown in FIG. 4.

The coordinate value manager 55, in the case of the determination result in Step ST12 being NO, i.e. case of the received coordinate value being a coordinate value of a control axis of the robot 3, acquires the received coordinate value as the robot reference coordinate value, and then advances to Step ST14. In Step ST14, the coordinate value manager 55 updates the current coordinate value stored in the robot coordinate value storage region 57a of the coordinate value memory 57 by the acquired robot reference coordinate value, and then ends the processing shown in FIG. 4.

The coordinate value manager 55 acquires the coordinate value sent from this robot control device 6 as the reference coordinate value by the sequence explained referencing FIG. 4, and updates the current coordinate value stored in the coordinate value memory 57 by this reference coordinate value.

Referring back to FIG. 2, the command generation unit 56, based on the current coordinate value stored in the coordinate value memory 57 and the analysis results of the robot program sent from the input analysis unit 54, generates the robot command for moving the control axis of the robot 3 and the travel axis command for moving the travel axis of the transfer device 4, writes the generated robot command and travel axis command in the data transmission unit 59, and then sends these commands to the robot control device 6.

More specifically, the command generation unit 56, in the case of being a state where the coordinate system is set to the robot coordinate system, and the command classification accompanying a change in coordinate value based on the robot program (i.e. case of G code being “G00” corresponding to positioning (rapid traverse), case of being “G01” corresponding to linear interpolation, etc.), generates a robot command according to the following sequence. In this case, the command generation unit 56 calculates the end point and speed of the control axis of the robot 3 under the designated coordinate format in the case of establishing the current coordinate value stored in the robot coordinate value storage region 57a of the coordinate value memory 57 as the start point of the control axis of the robot 3, generates a robot command including information related to this designated coordinate format, end point and speed, and writes in the data transmission unit 59. In addition, the command generation unit 56, after calculating the coordinate value of the end point of the control axis of the robot 3 by configuring in the above way, updates the current coordinate value stored in the robot coordinate value storage region 57a of the coordinate value memory 57 by the end point coordinate value calculated based on the robot program.

In addition, the command generation unit 56, in the case of being a state in which the coordinate system is set to the travel axis coordinate system, and the command classification accompanying a change in coordinate value based on the robot program (i.e. case of G code being “G00” corresponding to positioning (fast traverse), case of being “G01” corresponding to linear interpolation, etc., e.g.), generates a travel axis command according to the following sequence. In this case, the command generation unit 56 calculates the end point and speed of the travel axis of the transfer device 4 in the case of establishing the current coordinate value stored in the travel axis coordinate value storage region 57b of the coordinate value memory 57 as the start point of the travel axis of the transfer device 4, generates the travel axis command including this end point and information related to speed, and writes in the data transmission unit 59. In addition, the command generation unit 56, after calculating the coordinate value of the end point of the travel axis of the transfer device 4 by configuring in the above way, updates the current coordinate value stored in the travel axis coordinate value storage region 57b of the coordinate value memory 57, by the end point coordinate value calculated based on the robot program.

The data transmission unit 59, when the robot command and travel axis command are written by the command generation unit 56, sends this robot command and travel axis command to the data transmission unit 69 of the robot control device 6. In addition, the data transmission unit 59, when the travel axis coordinate value acquisition request, orthogonal coordinate value acquisition request and joint coordinate value acquisition request are written by the coordinate value manager 55 in accordance with the sequence explained by referencing FIG. 3, sends this travel axis coordinate value acquisition request, orthogonal coordinate value acquisition request and joint coordinate value acquisition request to the data transmission unit 69 of the robot control device 6.

The data transmission unit 59, when receiving the coordinate value sent from the data transmission unit 69 of the robot control device 6 in accordance with the sequence explained later, sends the received coordinate value to the coordinate value manager 55.

Next, the configuration of the robot control device 6 will be explained while referencing FIG. 2. As shown in FIG. 2, various functions such as of the input analysis unit 60, coordinate value control unit 61, robot program generation unit 62, operation control unit 63 and data transmission unit 69 are realized by the above-mentioned hardware configuration in the robot control device 6.

The input analysis unit 60 analyzes the command or request sent from the numerical control apparatus 5 via the data transmission unit 69, and sends the analysis result to the coordinate value control unit 61 and robot program generation unit 62.

More specifically, the input analysis unit 60, when the robot command or travel axis command is input from the data transmission unit 69, sends this robot command and travel axis command to the robot program generation unit 62. In addition, the input analysis unit 60, when the travel axis coordinate value acquisition request, orthogonal coordinate value acquisition request and joint coordinate value acquisition request are input from the data transmission unit 69, sends these coordinate value acquisition requests to the coordinate value control unit 61.

The coordinate value control unit 61 acquires the current coordinate value of the control axis of the robot 3 and the current coordinate value of the travel axis of the transfer device 4, in response to the coordinate value acquisition request sent from the input analysis unit 60, and writes the acquired coordinate value in the data transmission unit 69.

More specifically, the coordinate value control unit 61, when the travel axis coordinate value acquisition request is input from the input analysis unit 60, acquires the current coordinate value of the travel axis of the transfer device 4, and writes the acquired coordinate value in the data transmission unit 69. The coordinate value control unit 61, when the orthogonal coordinate value acquisition request is input from the input analysis unit 60, acquires the current coordinate value of the control axis of the robot 3 under the orthogonal coordinate format, and writes the acquired coordinate value in the data transmission unit 69. In addition, the coordinate value control unit 61, when the joint coordinate acquisition request is input from the input analysis unit 60, acquires the current coordinate value of the control axis of the robot 3 under the joint coordinate format, and writes the acquired coordinate value in the data transmission unit 69.

The robot program generation unit 62 generates a robot program according to the robot command or travel axis command sent from the input analysis unit 60. More specifically, the robot program generation unit 62, when the robot command is input from the input analysis unit 60, adds a robot instruction corresponding to this robot command to the robot program stored in a storage unit (not shown). In addition, the robot program generation unit 62, when the travel axis command is input from the input analysis unit 60, adds the travel axis instruction corresponding to this travel axis command to the above-mentioned robot program.

The operation control unit 63 boots the robot program generated by the robot program generation unit 62, and controls operation of the robot 3 and transfer device 4, by successively executing the robot instruction and travel axis instruction written in the booted robot program. More specifically, the operation control unit 63 calculates the target position of each control axis of the robot 3 by executing the robot instruction, generates robot control signals for the robot 3 by feedback controlling each servo motor of the robot 3 so that the calculated target position is realized, and inputs these to the servo motors of the robot 3. In addition, the operation control unit 63 calculates the target position of the travel axis of the transfer device 4 by executing the travel axis instruction, generates the travel axis control signal for the transfer device 4 by feedback controlling an actuator of the transfer device 4, and inputs this to the actuator of the transfer device 4.

The data transmission unit 69, when receiving the robot command, travel axis command, travel axis coordinate value acquisition request, orthogonal coordinate value acquisition request and joint coordinate value acquisition request sent from the data transmission unit 59 of the numerical control apparatus 5, sends the received commands and requests to the input analysis unit 60. In addition, the data transmission unit 69, when the coordinate value is written in accordance with the aforementioned sequence by the coordinate value control unit 61, sends the written coordinate value to the data transmission unit 59 of the numerical control apparatus 5.

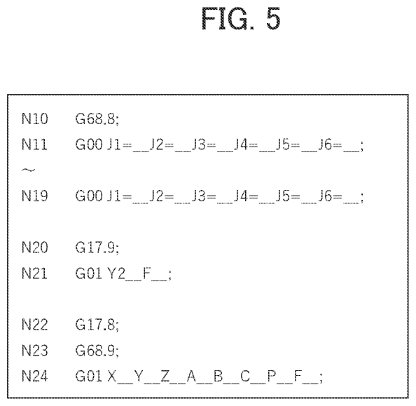

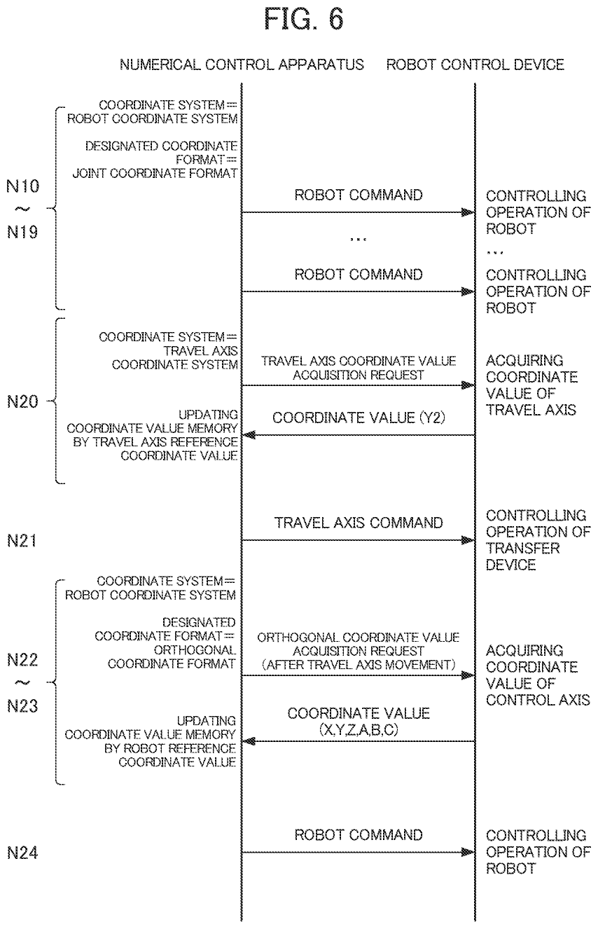

Next, the flow of various signals and information in the numerical control system 1 configured in the above way will be explained while referencing FIGS. 5 and 6.

FIG. 5 is an example of a robot program. FIG. 6 is a sequence diagram showing the flow of signals and information between the numerical control apparatus 5 and robot control device 6 in the case of operating the numerical control apparatus 5 based on the robot program exemplified in FIG. 5.

First, in the block indicated by sequence number “N10”, the command “G68.8” is input to the coordinate value manager 55 of the numerical control apparatus 5. The designated coordinate format of the coordinate system in the robot control module 51 of the numerical control apparatus 5 is thereby set to the joint coordinate format. Next, in the blocks indicated by sequence numbers “N11” to “N19”, command “G00 J1_J2 J3_J4_J5_J6” is input to the command generation unit 56 of the numerical control apparatus 5 based on the joint coordinate format in a state in which the coordinate system is set to the robot coordinate system. It should be noted that the coordinate value of the end point of the control axis of the robot 3 is input to the portion of an underscore in the command. The command generation unit 56 generates a robot command based on the current coordinate value stored in the robot coordinate value storage region 57a of the coordinate value memory 57 and the inputted command, and then sends this to the robot control device 6. The robot control device 6 controls operation of the robot 3 based on the received robot command.

Next, in the block indicated by sequence number “N20”, the command “G17.9” is input to the coordinate value manager 55 of the numerical control apparatus 5. The coordinate system of the robot control module 51 of the numerical control apparatus 5 thereby switches from the thus far robot coordinate system to the travel axis coordinate system. In addition, the coordinate value manager 55 sends the travel axis coordinate value acquisition request to the coordinate value control unit 61 of the robot control device 6, in response to switching the coordinate system of this block. The coordinate value control unit 61 of the robot control device 6 acquires the current coordinate value (Y2) of the travel axis of the transfer device 4 in response to receiving the travel axis coordinate value acquisition request, and sends this coordinate value to the coordinate value manager 55 of the numerical control apparatus 5. In addition, the coordinate value manager 55 of the numerical control apparatus 5 acquires the coordinate value sent from the robot control device 6 as the travel axis reference coordinate value, and updates the current coordinate value stored in the travel axis coordinate value storage region 57b of the coordinate value memory 57 by this travel axis reference coordinate value.

Next, in the block indicated by sequence number “N21”, the command “G01 Y2_F_” is inputted to the command generation unit 56 of the numerical control apparatus 5 based on the travel axis coordinate system in a state in which the coordinate system was set to the travel axis coordinate system. It should be noted that the coordinate value and speed value of the end point of the travel axis of the transfer device 4 are input to the portion of the underscore in the command. The command generation unit 56 generates a travel axis command based on the current coordinate value stored in the travel axis coordinate value storage region 57b of the coordinate value memory 57, and inputted command, and then sends this to the robot control device 6. The robot control device 6 controls operation of the transfer device 4 based on the received travel axis command.

Next, in the blocks indicated by sequence numbers “N22” and “N23”, the commands “G17.8” and “G68.9” are input to the coordinate value manager 55 of the numerical control apparatus 5. The coordinate system of the robot control module 51 of the numerical control apparatus 5 thereby switches from the thus far travel axis coordinate system to the robot coordinate system, and the designated coordinate format is set to the orthogonal coordinate format. In addition, the coordinate value manager 55 sends the orthogonal coordinate value acquisition request to the coordinate value control unit 61 of the robot control device 6, in response to switching the coordinate system and designated coordinate format in these blocks. The coordinate value control unit 61 of the robot control device 6, in response to receiving the orthogonal coordinate value acquisition request, acquires the current coordinate value of the robot 3, i.e. the coordinate values (X, Y, Z, A, B, C) under the orthogonal coordinate format of the control axis of the robot 3 after travel axis movement in the sequence number “N21”, and sends this coordinate value to the coordinate value manager 55 of the numerical control apparatus 5. In addition, the coordinate value manager 55 of the numerical control apparatus 5 acquires the coordinate value sent from the robot control device 6 as the robot reference coordinate value, and updates the current coordinate value stored in the robot coordinate value storage region 57a of the coordinate value memory 57 by this robot reference coordinate value.

Next, in the block indicated by sequence number “N24”, the command “G01 X_Y_Z_A_B_C_P_F_” is inputted to the command generation unit 56 of the numerical control apparatus 5, based on the orthogonal coordinate format in a state in which the coordinate system was set to the robot coordinate system. It should be noted that the coordinate value and speed value of the end point of the control axis of the robot 3 are input to the portion of the underscore in the command. The command generation unit 56 generates the robot command based on the current coordinate value stored in the robot coordinate value storage region 57a of the coordinate value memory 57, and the inputted command, and then sends this to the robot control device 6. The robot control device 6 controls operation of the robot 3 based on the received robot command.

The present disclosure is not limited to the above-mentioned embodiment, and various changes and modifications thereto are possible.

### EXPLANATION OF REFERENCE NUMERALS

1 numerical control system
2 machine tool
3 robot
4 transfer device
5 numerical control apparatus
50 machine tool control module
51 robot control module
52 storage unit
53 program input unit
54 input analysis unit
55 coordinate value manager
56 command generation unit
57 coordinate value memory
57a robot coordinate value storage region
57b travel axis coordinate value storage region
59 data transmission unit
6 robot control device
60 input analysis unit
61 coordinate value control unit
62 robot program generation unit
63 operation control unit
69 data transmission unit

1. A numerical control apparatus for controlling operation of a machine tool based on a numerical control program, and generating and inputting to a robot control device, in relation to the robot control device which controls operations of a robot and of a transfer device that moves the robot, a robot command for moving a robot control axis of the robot and an additional axis command for moving an additional axis of the transfer device, the numerical control apparatus comprising:
a coordinate value manager which acquires coordinate values of the robot control axis and the additional axis acquired in the robot control device, respectively, as a robot reference coordinate value and an additional axis reference coordinate value; and
a command generation unit which generates the robot command and the additional axis command based on the numerical control program, the robot reference coordinate value and the additional axis reference coordinate value.

2. The numerical control apparatus according to claim 1, wherein the coordinate value manager acquires the robot reference coordinate value or the additional axis reference coordinate value from the robot control device, based on a coordinate system switching command of the numerical control program.

3. The numerical control apparatus according to claim 2, wherein the coordinate value manager manages a robot current coordinate value, which is a current coordinate value of the robot control axis, and an additional axis current coordinate value, which is a current coordinate value of the additional axis, based on the robot reference coordinate value and the additional axis reference coordinate value.

4. A numerical control system comprising: a numerical control apparatus which controls operation of a machine tool based on a numerical control program, and generates a robot command for moving a control axis of a robot and an addition axis command for moving an additional axis of a transfer device which moves the robot; and
a robot control device which is configured to be communicably with the numerical control apparatus, and controls operation of the robot and the transfer device based on the robot command and the additional axis command sent from the numerical control apparatus,
wherein the robot control device includes:
a coordinate value control unit which acquires a coordinate value of the robot control axis and a coordinate value of the additional axis according to a coordinate value acquisition request sent from the numerical control apparatus, and sends these to the numerical control apparatus, and
an operation control unit which controls operation of the robot and the transfer device based on the robot command and the additional axis command; and
wherein the numerical control apparatus includes:
a coordinate value manager which acquires a coordinate value of the robot control axis and a coordinate value of the additional axis sent from the robot control device, respectively, as a robot reference coordinate value and an additional axis reference coordinate value, and
a command generation unit which generates the robot command and the additional axis command, based on the numerical control program, the robot reference coordinate value and the additional axis reference coordinate value.

5. The numerical control system according to claim 4, wherein the coordinate value manager generates and sends to the robot control device the coordinate value acquisition request based on a coordinate system switching command of the numerical control program.

6. The numerical control system according to claim 5, wherein the coordinate value manager manages a robot current coordinate value, which is a current coordinate value of the robot control axis, and an additional axis current coordinate value, which is a current coordinate value of the additional axis, based on the robot reference coordinate value and the additional axis reference coordinate value.
